(19) United States
(12) Patent Application Publication
(10) Pub. No.: US 2026/0352075 A1
(43) Pub. Date: Nov. 5, 2026

(54) Method for Attaching a Wire to a Connection Element, and Connection Arrangement

(71) Applicant: Bayerische Motoren Werke Aktiengesellschaft, Muenchen (DE)

(72) Inventors: Friedrich MANDL, Muenchen (DE); Kirstin STEINER, Muenchen (DE)

(21) Appl. No.: 19/484,987

(22) PCT Filed: Jun. 11, 2024
(86) PCT No.: PCT/EP2024/066057

§ 371 Date: Nov. 17, 2025

(30) Foreign Application Priority Data
Jun. 20, 2023 (DE) 10 2023 116 069.9

(51) Int. Cl. H02K 15/33; H02K 3/52

(52) U.S. Cl. CPC H02K 15/33; H02K 3/522

(57) ABSTRACT

A method for attaching a wire to a connection element. The method includes strain hardening the wire by cold forming and, after the strain hardening of the wire, hot-crimping the wire to the connection element. In an embodiment, the wire is a winding wire of a rotor of an electrical machine.

### BACKGROUND AND SUMMARY

The invention relates to a method for attaching a wire to a connection element, and to a connection arrangement of a wire to a connection element.

DE 10 2007 021 321 A 1 discloses a stator of an electrical machine having multiple coils, which coils are interconnected on one side of the stator. The stator moreover comprises at least one conductor rail which is interconnected with two of the multiple coils, wherein the ends of the conductor rail are respectively hot-crimped or welded to one end of one of the coils.

Moreover, a connection system is known from DE 10 2017 205 078 A 1 for the formation of an electrical and mechanical connection between at least one electrical conductor and a connection element. The connection system comprises a spring clamp and the connection element, wherein the at least one conductor and the connection element are mutually connected in a form-fitted and electrically conductive manner. The at least one electrical conductor and the connection element are mutually mechanically attachable by means of the spring clamp wherein, in a mechanically attached state, the at least one electrical conductor is clamped between the connection element and the spring clamp.

The object of the present invention is the provision of a solution which enables a particularly durable connection of a wire to a connection element.

According to the invention, this object is fulfilled by the subject matter of the independent claims. Further potential configurations of the invention are disclosed in the subclaims, in the description and in the figures. Features, advantages and potential configurations which are represented in the context of the description of any subject matter of the independent claims are to be considered as at least analogous to features, advantages and potential configurations of the respective subject matter of the other independent claims, and of any potential combination of the subject matter of the independent claims, optionally in combination with one or more of the subclaims.

The invention relates to a method for attaching a wire to a connection element, wherein the wire is cold-formed in order to establish strain hardening, and is then hot-crimped to the connection element. The wire, in particular, is a thin and elongated flexible component, which is formed of a metal. In particular, the wire assumes a circular cross-section. Alternative cross-sectional shapes are also possible. In particular, the wire is electrically conductive. By means of the connection between the wire and the connection element, an electrical connection of the wire to the connection element is established. By means of the connection between the wire and the connection element, an electrical connection can thus be provided.

In order to achieve a particularly high durability of this connection, the wire is firstly strain hardened, and is then hot-crimped to the connection element. As a result, a particularly fine structure of the wire is formed, as a result of which a particularly high cyclical loading capacity of the wire is achieved. The principle of strain hardening is based upon the introduction of additional dislocations into a material during plastic deformation. In any plastic deformation process, new dislocations are invariably introduced into the material. Dislocations prevent any mutual creep thereof, thereby resulting in a strengthening action. By means of strain hardening, a plastic deformation of the material only occurs at higher strain values. This means that the strain hardened material assumes a higher yield point. For the purposes of strain hardening, the wire undergoes cold forming. In the present context, forming is to be understood as the plastic reforming of metals below the crystallization temperature. As a result of the hardening thus generated, the material strength is increased. The recrystallization temperature is of the order of 40 to 50 percent of the absolute melting temperature, and is dependent upon the material and the degree of reforming applied. By means of cold forming, an increase in strength and a reduction of ductility, and thus of elongation at break, can be achieved.

Crimping is understood as a joining process in which two components are mutually connected by means of plastic deformation, for example by beading, flattening, dimpling or folding. A crimped connection is only conditionally detachable and, in the event of repairs, can only be restored by means of an appropriate tool. Crimping enables the formation of a uniform and detachment-resistant electrical connection between a conductor, in particular a wire, and a connected element, in particular a connection element. This connection ensures a high degree of electrical and mechanical security.

Hot-crimping or thermo-crimping is a technique from the field of resistance welding. A combination of pressure and an introduction of thermal energy generates a permanent bond. Thermal energy can be introduced by the infeed of electric current into the wire. Alternatively, the process can be executed in the absence of a current flux, using a thermal flux only, wherein a heat-up of the crimping tool, for example, is executed by means of induction, or in a kiln. Crimping thus has an ancillary effect in that, by means of heat generated, any coat of insulating lacquer which is present on the wire is burnt off. Any chemical or mechanical removal of the insulating lacquer from the wire prior to the formation of the connection can thus be omitted. A particularly rapid connection of the wire to the connection element is thus enabled, even in the event that the wire is a wire which is coated with an insulating lacquer. The key parameters for the formation of a connection using a hot-crimping technique are the pressure applied for the formation of the crimped connection, the quantity of heat or thermal energy, for example of heat which is generated by the electrical or thermal resistance of the material which is to be welded upon the infeed of an electric current, and the time during which the heat thus generated acts on the material. The resulting connection is characterized by a very high electrical conductivity and a low electrical contact resistance. By means of hot-crimping, a recrystallization of the structure of the wire can be achieved wherein, as a result of strain hardening prior to hot crimping, a particularly fine-grained structure can be generated. This is advantageous with respect to a cyclical loading capacity. The method thus enables the formation of an electrical connection between the wire and the connection element having a particularly high mechanical stability.

According to one potential further development of the invention, it is provided that, by way of a wire, an unalloyed or low-alloy copper wire is fastened to the connection element. A copper wire having a copper content in excess of 95%, according to the IACS, is thus employed. In particular, in the event of the employment of a copper wire, as a result of strain hardening and subsequent hot-crimping, a particularly fine-grained structure can be achieved. In consequence, particularly in the event of the employment of an unalloyed copper wire, a particularly stable mechanical connection between the wire and the connection element can be achieved.

In particular, in this context, it can be provided that the wire is comprised of Cu-ETP, or Cu-OF, or Cu-OFE, or Cu-DHP, or Cu-HCP. Cu-ETP is a grade of copper which is produced by electrolytic refining, and having a residual oxygen content. This material assumes a very high electrical conductivity, and is particularly cost-effective. Cu-OF is a highly purified and oxygen-free copper, containing at least 99.99 percent Cu. This material combines the advantages of Cu-ETP with those of phosphorous deoxidized copper. The high degree of purity and the absence of oxide inclusions enable 100 percent IACS electrical conductivity. Cu-OF moreover shows no susceptibility to hydrogen embrittlement. Cu-OF assumes very good forming properties, and is appropriate for welding and brazing. In these respects, Cu-OF is superior to the alloy Cu-ETP. Cu-OFE is a highly purified, non-deoxidized and oxygen-free copper which contains no elements which are vaporizable in a vacuum and which assumes a high electrical and thermal conductivity. This grade of copper, in addition to very good hot and cold forming properties, also shows good corrosion resistance, particularly upon exposure to atmospheres (as a result of an adherent oxide layer) or water, and is practically impervious to stress corrosion cracking. This material is resistant to thermal treatment in a reducing atmosphere, and can be welded, brazed and soft-soldered in a highly effective manner. Cu-DHP is a deoxidized oxygen-free copper having a degree of residual phosphorous content. This material combines good reforming properties with suitability for welding and brazing, wherein conductivity is reduced as a result of the residual phosphorous content. Cu-HCP is a highly purified and deoxidized copper having a low residual phosphorous content, and which assumes a high electrical and thermal conductivity. This grade of copper, in addition to very good hot and cold forming properties, also shows good corrosion resistance, particularly upon exposure to atmospheres (including industrial atmospheres) and water. This material assumes good welding and brazing properties, and is hydrogen-resistant. The above-mentioned unalloyed grades of copper, further to cold forming and subsequent hot-crimping, respectively assume a particularly fine structure, as a result of which a particularly high cyclical loading capacity can be achieved.

According to a further potential configuration of the invention, it is provided that, by way of a wire, a winding wire of an active part of an electrical machine, in particular of a rotor, is attached to the connection element. Alternatively, the active part can be a stator of the electrical machine. In particular, the winding wire is an element of a coil component of the electrical machine. In particular, the connection element can be secured to a connector ring of the rotor. The method thus enables the winding wire to be bonded to the connector ring of the rotor in a particularly secure and electrically conductive manner. The wire is thus the electrical conductor of the rotor, which conductor is wound to form a coil. The method thus enables a particularly durable bonding of the winding wire to the connection element and thus, via the connection element, to the connector ring of the rotor. As a result, a particularly long service life of the rotor can be achieved.

In this context, in particular, it can be provided that the winding wire, upon the winding thereof about a plate stack of the active part, undergoes strain hardening by means of reforming using a stator winding needle. This means that the strain hardening of the wire takes place during the winding of the winding wire about the plate stack. Strain hardening can thus be introduced into the wire by means of the winding needle wherein, by means of the winding needle, the wire undergoes strain hardening in conjunction with the winding of the wire about the plate stack. By an adjustment of the winding technique employed, or by a setting of the orientation of the winding needle, the degree of cold forming and, in consequence, the strain hardening of the wire can be adjusted in an accurate manner. Alternatively, the introduction of cold forming can be executed by a deflection of the wire ahead of the winding needle, for example by a guidance of the wire by means of a corresponding arrangement of deflection rollers having “small”′ radii. By the strain hardening of the wire in conjunction with the winding thereof about the plate stack, the active part can be produced in a particularly rapid manner, wherein strain hardening and the winding of the winding wire about the plate stack are executed simultaneously.

In this context, in particular, it can be provided that a deflection angle of the winding wire, upon the winding thereof about the plate stack by means of the winding needle, is selected in accordance with a strain hardening of the winding wire which is to be achieved. The greater the degree of deflection of the winding wire during the winding thereof by means of the winding needle, the higher the setting of the strain hardening of the winding wire thus achieved. In particular, the deflection angle of the winding wire is selected such that any excessive strain hardening of the winding wire, which might result in a localized destruction or failure of the winding wire, is suppressed. This means that the deflection angle is selected such that the winding wire is cold formed to a sufficient degree for the achievement of the stipulated strain hardening, but is not cold formed to the extent that any damage to the winding wire occurs. For the setting of the deflection angle, in particular, an incident angle and/or course of motion of the winding angle can be adjusted, in order to achieve the reforming of the winding wire through the stipulated deflection angle. It can thus be ensured that the wire undergoes sufficient cold forming for the achievement of the stipulated strain hardening, wherein the risk of damage to the wire is restricted to a particularly low level.

According to a further potential configuration of the invention, it is provided that the winding wire firstly undergoes strain hardening by means of cold forming, is then wound about the plate stack of the coil component, and is hot-crimped to the connection element thereafter. In other words, the winding wire is cold formed prior to winding thereof about the plate stack. The previously cold formed winding wire is then wound about the plate stack. As the winding of the winding wire about the plate stack and the strain hardening of the winding wire are executed in a mutually separate manner, strain hardening and the winding of the winding wire about the plate stack can be respectively optimized. This means that the winding wire can undergo strain hardening, independently of any respective deflection limits which are in force during the winding of the winding wire about the plate stack. Moreover, during the winding process of the winding wire about the plate stack, it is possible for the winding of the wire about the plate stack to be optimized, wherein no observation of deflection angles for the strain hardening of the winding wire is required, as the wire which is wound about the plate stack has previously been strain hardened. The winding wire can thus be cold formed in an optimum manner, and wound about the plate stack thereafter in an optimum manner.

According to a further potential configuration of the invention, it is provided that the wire, during hot-crimping, at least in some areas, undergoes heat-up to a temperature of 450 to 900 degrees Celsius and/or for a duration of 100 to 1,200 milliseconds. The temperature and the duration of heat-up during hot-crimping are selected in accordance with a desired recrystallization of the wire structure. On the grounds that the wire, during hot-crimping, at least in some areas, undergoes heat-up to a temperature of 450 to 900 degrees Celsius and/or for a duration of 100 to 1,200 milliseconds, a particularly fine structure of the wire and, in consequence, a particularly high cyclical loading capacity of the wire and, in particular, of the connection of the wire to the connection element are achieved further to hot-crimping.

According to a further potential configuration of the invention, it is provided that, for the purposes of pre-fixing, the wire is firstly cold-crimped to the connection element, and the wire is then hot-crimped to the connection element at the same location. By the cold-crimping of the wire to the connection element, the wire can be positioned relative to the connection element, and maintained in this position in a particularly secure manner. Thereafter, the wire can be securely and permanently bonded in this position relative to the connection element by hot-crimping, particularly in a materially bonded manner. Pre-fixing by cold-crimping enables a particularly accurate positioning and orientation of the wire vis-à-vis the connection element. By cold-crimping, it is to be understood that a crimping of the wire to the connection element is executed, wherein any heat-up of either the wire or of the connection element is omitted. By the reforming of the wire associated with cold-crimping, moreover, a localized strain hardening can be introduced into the wire which is to be crimped.

According to a further potential configuration of the invention, it is provided that the wire, further to hot-crimping, is cold-crimped to the connection element at the same location. As a result, a further increase in the strength of the crimped connection can be achieved. A particularly secure connection between the wire and the connection element is thus obtained.

The invention further relates to a connection arrangement of a wire to a connection element, wherein the wire which is cold formed for the purposes of strain hardening is attached to the connection element by means of a hot-crimped connection. As a result, the wire, by means of a recrystallization which is generated during hot-crimping, assumes a particularly fine structure. In particular, the connection arrangement is an element of an active part, in particular of a coil component, of an electrical machine. In particular, the electrical machine can be a traction machine of an electrically powered motor vehicle. In particular, the active part can be a rotor of the electrical machine. In this case, the wire can be a winding wire of the rotor, which wire is wound about a plate stack of the rotor, by way of a coil winding. The connection element can be attached to a connector ring of the rotor, as a result of which, by means of the connection arrangement, the coil winding is electrically connected to the connector ring.

Further features of the invention proceed from the claims, the figures, and the description of the figures. Features and combinations of features specified in the preceding description, and features and combinations of features specified hereinafter in the description of the figures and/or represented in the figures only, are not only applicable in the respectively indicated combination, but also in other combinations, or in isolation, without departing from the scope of the invention.

### BRIEF DESCRIPTION OF THE DRAWINGS

FIG. 1 shows a process diagram of a method for attaching a wire to a connection element; and

FIG. 2 shows a schematic perspective view of a rotor of an electrical machine, having a connection arrangement of a wire to the connection element.

### DETAILED DESCRIPTION OF THE DRAWINGS

In the figures, identical and functionally equivalent elements are identified by the same reference symbols.

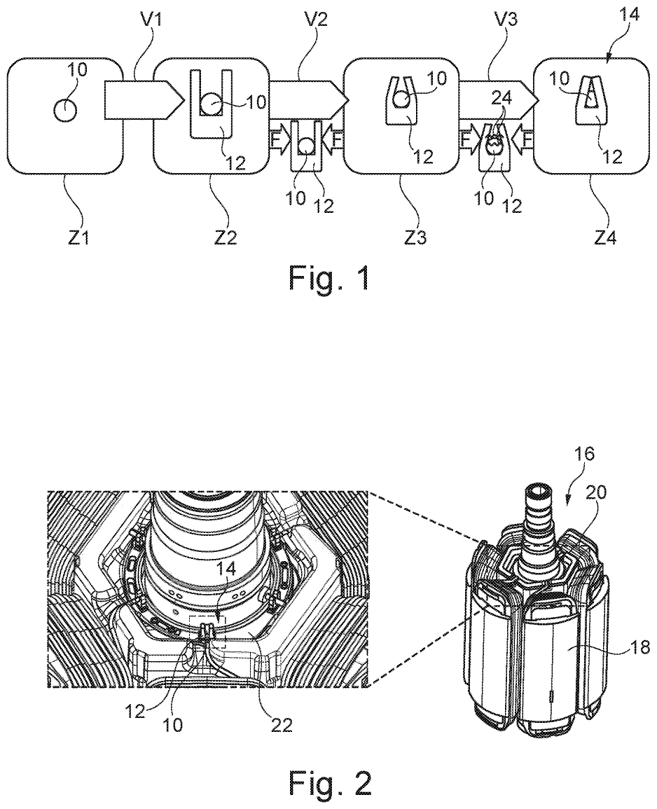

FIG. 1 shows a process diagram of a method for attaching a wire 10 to a connection element 12. As a result of the attachment of the wire 10 to the connection element 12, a connection arrangement 14 of the wire 10 to the connection element 12 is formed. FIG. 2 shows an exemplary context in which this connection arrangement 14 can be employed. FIG. 2 shows a schematic perspective view of a rotor 16 of an electrical machine, in the present case a traction machine of a motor vehicle. This rotor 16 comprises a plate stack 18, about which the wire 10 is wound, as a result of which a rotor coil 20 of the rotor 16 is provided. The wire 10 is thus a winding wire of the rotor 16. In the present case, the wire 10 is an unalloyed or low-alloy copper wire, in particular of Cu-ETP, or of Cu-OF, or of Cu-DHP.

In FIG. 2, the rotor 16 is additionally shown in an enlarged sectional representation. It can thus be seen that the connection element 12 is attached to a connector ring 22 of the rotor 16. By means of the connection arrangement 14, the wire 10 is thus connected to the connector ring 22, in an electrically conductive manner, via the connection element 12.

In the present case, the connection element 12 is configured with a fork-shaped design, wherein the wire 10 for connecting to the connection element 12 is inserted between the two tines of the fork-shaped connection element 12.

The method for attaching the wire 10 to the connection element 12 is explained hereinafter in conjunction with FIG. 1. In the respectively outlined panels, the state Z of the wire 10 is illustrated at different time points of the method. In the first panel, the wire 10 is illustrated in a first state Z1—the original state thereof. Proceeding from this first state Z1, the wire 10 undergoes strain hardening by cold forming in a first process step V1. The wire 10 can either firstly undergo strain hardening by cold forming, and then be wound about the plate stack 18 of the rotor 16, or can undergo strain hardening by cold forming simultaneously with the winding thereof about the plate stack 18. The requisite strain hardening is critically implemented by means of the geometry of a winding needle, by means of which the wire 10 is applied to the plate stack 18. This means that the wire 10, upon the winding thereof about the plate stack 18, undergoes strain hardening associated with reforming by means of the winding needle. A deflection angle of the wire 10 during the winding thereof about the plate stack 18 by means of the winding needle is thus selected in accordance with a strain hardening of the wire 10 which is to be achieved.

Alternatively, the previously strain hardened wire 10 is employed for the winding process. This means that the winding wire is firstly strain hardened by cold forming, is then wound about the plate stack 18 of the rotor 16, and is subsequently hot-crimped to the connection element 12. The strain hardened wire 10 is inserted into the connection element 12, which element is configured with a fork-shaped design, as a result of which the second state Z2, which is illustrated in the second panel, is achieved. As can be seen particularly clearly in the second panel, in the present case, the connection element 12 assumes a U-shaped cross-section, wherein the wire 10 is inserted into the recess of the connection element 12 via the open side of the U-shaped cross-section. The wire 10 can thus engage in contact with the base of the recess in the U-shaped cross-section of the connection element 12, or is supported by the tines of the fork-shaped structure only. Alternatively, the connection element 12 can assume a V-shaped cross-section, wherein the wire 10 is inserted into the recess of the connection element 12 via the open side of the V-shaped cross-section. In a second process step V2, the wire 10 is then cold-crimped to the connection element 12. A mechanical force F is applied to the connection element 12 and to the wire 10. The cold-crimped third state Z3 of the wire 10 with the connection element 12, which state is illustrated in the third panel, is achieved as a result. Further to cold-crimping, the wire 10 and the connection element 12 are hot-crimped in a third process step V3. A mechanical force F is applied to the connection element 12 and to the wire 10 and, at the same time, heat 24 is introduced at least into the wire 10. In the present case, hot-crimping is executed within a temperature range of 450 to 900 degrees Celsius, wherein the wire 10 and, optionally, also the connection element 12 undergo hot-crimping for a duration of 100 to 3,000 milliseconds, in particular for a duration of 100 to 1,200 milliseconds. It is to be understood hereby that the temperature setting for hot-crimping is maintained for a duration of 100 to 3,000 milliseconds, in particular for 100 to 1,200 milliseconds, and that the application of the mechanical force F is maintained for a duration of 100 to 3,000 milliseconds, in particular for a duration of 100 to 1,200 milliseconds. In the fourth panel, the hot-crimped fourth state Z4 of the wire 10 is represented. This means that, for the purposes of pre-fixing, the wire 10 is firstly cold-crimped to the connection element 12, and the wire 10 is then hot-crimped to the connection element 12 at the same location.

For the implementation of further strain hardening further to the recrystallization of the wire, and thus for the further enhancement of strength, the hot-crimped connection can then undergo a further cold-crimping.

In the event that a wire which is lacquered with an insulating lacquer is employed as the wire 10, the lacquer is then burnt off as a result of the influence of temperature associated with hot-crimping. Further to cold-crimping, a materially bonded connection of the wire 10 to the connection element 12 is thus executed by means of the hot-crimping process. By means of the associated thermal treatment, on the grounds of a recrystallization of the material structure, a fine structure of the wire 10, and thus a fine-grained microstructure, is formed. This is advantageous with respect to a long-term strength of the connection arrangement 14. A strain hardened wire 10 having a hardness of 90HV 0.1 , further to the introduction of energy associated with hot-crimping, as a result of which a recrystallization of the structure of the wire 10 occurs, assumes a particularly fine-grained structure. This structure assumes a particularly good cyclical loading capacity. Further to hot-crimping, the hardness of this wire 10 is of the order of 55 to 60HV 0.1 .

The method described enables the achievement of a particularly high long-term strength of the hot-crimped connection of the wire 10 to the connection element 12.

Overall, the invention demonstrates how a durable current-carrying copper connection can be provided.

### LIST OF REFERENCE CHARACTERS:

10 Wire
12 Connection element
14 Connection arrangement
16 Rotor
18 Plate stack
20 Rotor winding
22 Connector ring
24 Heat
Z1 to Z4 States of wire
F Application of force
V1 to V3 Process steps

1.-11. (canceled)

12. A method for attaching a wire to a connection element, comprising the steps of:
strain hardening the wire by cold forming; and
after the strain hardening, hot-crimping the wire to the connection element.

13. The method according to claim 12, wherein the wire is an unalloyed or low-alloy copper wire.

14. The method according to claim 13, wherein the wire is comprised of Cu-ETP or Cu-OF or Cu-OFE or Cu-DHP or Cu-HCP.

15. The method according to claim 12, wherein the wire is a winding wire of a rotor of an electrical machine.

16. The method according to claim 15, wherein the cold forming is performed during winding of the winding wire about a plate stack of the rotor by reforming using a winding needle.

17. The method according to claim 16, wherein a deflection angle of the winding wire, upon the winding of the winding wire about the plate stack, is selected to achieve a setting of the strain hardening.

18. The method according to claim 15, wherein after the strain hardening and before the hot-crimping, the method further comprises winding the winding wire about a plate stack of the rotor.

19. The method according to claim 12, wherein the wire, during the hot-crimping, at least in an area, undergoes heat-up to a temperature of 450-900 °C and/or for a duration of 100-3,000 milliseconds.

20. The method according to claim 12, further comprising the step of pre-fixing the wire to the connection element by cold-crimping the wire to the connection element at a location, wherein the hot-crimping is performed at the location.

21. The method according to claim 12, further comprising the step of cold-crimping the wire to the connection element at a same location as the hot-crimping.

22. A connection arrangement, comprising:
a wire, wherein the wire is strain hardened by cold forming; and
a connection element;
wherein the wire is attached to the connection element by a hot-crimped connection and wherein the wire has a fine-grained structure as a result of recrystallization of the wire by the hot-crimped connection.
